(19) United States
(12) Patent Application Publication
(10) Pub. No.: US 2020/0148030 A1
(43) Pub. Date: May 14, 2020

(54) VEHICLE HVAC ZONE ASSEMBLY

(71) Applicant: Calsonic Kansei North America, Inc., Farmington Hills, MI (US)

(72) Inventor: Scott Torok, Farmington Hills, MI (US)

(21) Appl. No.: 16/186,041

(22) Filed: Nov. 9, 2018

(51) Int. Cl. B60H 1/00; B60H 1/24

(52) U.S. Cl. CPC B60H 1/00485; B60H 1/00028; B60H 1/241; B60H 1/00564

(57) ABSTRACT

A zone assembly for a vehicle includes a housing and a generally cylindrical mode door. The housing includes a cavity, an inlet channel, a first vent channel, and a second vent channel. Each of the channels is fluidly coupled to the cavity. The mode door includes a plurality of louvers and a plurality of extension pieces extending therefrom. The mode door is located in the cavity. The mode door is rotatable between an open position in which fluid may flow from the inlet channel through the mode door to one of the first vent channel or the second vent channel, and a closed position in which the mode door restricts fluid from flowing from the inlet to both the first vent channel and the second vent channel.

### BACKGROUND

The present disclosure relates generally to systems used to control the flow of air from a heating and/or cooling system in a vehicle. More specifically, the present disclosure relates to a zone assembly configured to direct the flow of air toward different locations in a vehicle cabin.

Conventional vehicles typically include a vehicle body defining a space such as a vehicle cabin within which a user may be positioned. The vehicle body may be configured to fully surround the user and protect the user from weather and other road related hazards. The space may be at least partially sealed off from the vehicle surroundings. The vehicle may additionally include a cooling and/or heating system configured to maintain user comfort during vehicle operation. The heating/cooling system typically includes a combination of ducts, fans, and flow valves configured to route conditioned air toward different areas within the vehicle cabin.

Larger vehicles traditionally include ducts configured to deliver conditioned air to a rear portion of the vehicle cabin. Control over the delivery of air to the rear portion is typically provided by two valves, an on/off flow control valve and one or more directional valves that isolate the flow to different areas within the rear portion.

### SUMMARY

At least one embodiment relates to a heating, ventilation, and air conditioning (HVAC) zone assembly including a housing. The housing includes a cavity, an inlet channel, a first vent channel, and a second vent channel. Each of the channels extend from the cavity and are fluidly coupled to the cavity. The zone assembly also includes a generally cylindrical mode door located in the cavity. The mode door includes a plurality of louvers and a plurality of extension pieces extending therefrom. The mode door is rotatable between an open position in which fluid may flow from the inlet channel through the mode door to one of the first vent channel or the second vent channel, and a closed position in which the mode door restricts fluid from flowing from the inlet channel to both the first vent channel and the second vent channel.

Another embodiment is a mode door for an HVAC system. The mode door includes cylindrical caps disposed on either end of the mode door and a plurality of louvers therebetween. The louvers define at least one substantially longitudinal flow passage. The mode door additionally includes a plurality of extension pieces. Each extension piece is at least partially disposed on a louver and extends outward from the louver. The mode door is configured to be received within a cavity of a housing. Each extension piece is configured to restrict air from flowing through a separation between the mode door and the housing.

Another embodiment is a housing for an HVAC zone assembly. The housing includes a cavity configured to receive a mode door. The housing includes an inlet channel, a first vent channel, and a second vent channel. Each of the channels extend from the cavity. The cavity includes a first arcuate section that extends between the inlet channel and the first vent channel, a second arcuate section that extends between the inlet channel and the second vent channel, and a third arcuate section that extends between the first vent channel and the second vent channel.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of an HVAC zone assembly for a vehicle, according to an illustrative embodiment.

FIG. 2 is a side cross-sectional view of the HVAC zone assembly of FIG. 1, according to an illustrative embodiment.

FIG. 3 is a perspective view of a first portion of a housing for the zone assembly of FIG. 1, according to an illustrative embodiment.

FIG. 4 is a side view of the first portion of the housing of FIG. 3,

FIG. 5 is a perspective view of a second portion of a housing for the zone assembly of FIG. 1, according to an illustrative embodiment.

FIG. 6 is a side view of the second portion of the housing of FIG. 5.

FIG. 7 is a perspective view of a partition member for the zone assembly of FIG. 1, according to an illustrative embodiment.

FIG. 8 is a side view of the partition member of FIG. 7.

FIG. 9 is a perspective view of a mode door for the zone assembly of FIG. 1, according to an illustrative embodiment.

FIG. 10 is a side view of the mode door of FIG. 9.

FIG. 11 is a perspective view of a mode actuator for the zone assembly of FIG. 1, according to an illustrative embodiment.

FIG. 12 is a side view of the mode actuator of FIG. 11.

FIG. 13 is a block diagram of a control system for the zone assembly of FIG. 1, according to an illustrative embodiment.

FIG. 14 is a side cross-sectional view of the zone assembly of FIG. 1 with the mode door in a closed position, according to an illustrative embodiment.

FIG. 15 is a side cross-sectional view of the zone assembly of FIG. 1 with the mode door in a closed position, according to another illustrative embodiment.

FIG. 16 is a side cross-sectional view of the zone assembly of FIG. 1 with the mode door in a vent position, according to an illustrative embodiment.

FIG. 17 is a side cross-sectional view of the zone assembly of FIG. 1 with the mode door in a vent position, according to another illustrative embodiment.

FIG. 18 is a side cross-sectional view of the zone assembly of FIG. 1 with the mode door in a floor position, according to an illustrative embodiment.

FIG. 19 is a side cross-sectional view of the zone assembly of FIG. 1 with the mode door in a floor position, according to another illustrative embodiment.

FIG. 20 is a side cross-sectional view of the zone assembly of FIG. 1 with the mode door in a bi-level position, according to an illustrative embodiment.

FIG. 21 is a side cross-sectional view of the zone assembly of FIG. 1 with the mode door in a bi-level position, according to another illustrative embodiment.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a heating, ventilation, and air conditioning (HVAC) zone assembly is configured to provide and distribute conditioned air to a vehicle cabin within a vehicle. The HVAC zone assembly includes a housing including an inlet channel and multiple outlet or vent channels. Each vent channel is configured to direct air to different regions, areas, etc. within the vehicle cabin. The HVAC zone assembly includes a rotatable mode door that, advantageously, is configured both as an on/off valve to allow conditioned air received through the inlet channel (e.g., from an HVAC system) to pass through the zone assembly, and as a directional valve to isolate the delivery of air to one or more regions within the vehicle cabin.

The housing includes a wall defining a cavity within which the mode door is received. The mode door includes a plurality of extension pieces that are configured to prevent air from bypassing the mode door between an outer perimeter of the mode door and the wall of the housing. The mode door is configured such that at least two extension pieces block air from bypassing the mode door when the mode door is positioned to close off the vent channel. The added restriction helps to prevent any air from bleeding into a closed-off vent channel, which is at a lower pressure than the inlet channel. The mode door is further configured such that only one extension piece blocks air from bypassing the mode door when the mode door is positioned to fluidly couple the inlet channel to the vent channel.

In an embodiment, the mode door is substantially cylindrical and symmetrical about a plane passing through a central axis of the mode door. Among other benefits, this provides two substantially identical rotational positions, which are 180° out of phase from one another. The mode door includes a cylindrical cap disposed at either axial end of the mode door. The mode door additionally includes a plurality of louvers extending between the cylindrical caps. Together, the louvers define at least one substantially longitudinal passage configured to direct the flow of air from the inlet channel through the mode door to one or more of the vent channels. The louvers may be configured to completely block off the inlet channel when the mode door is in a closed position, thereby eliminating the need for a separate on/off flow control valve upstream of the mode door. These and other advantageous features will become apparent to those review the present disclosure and figures.

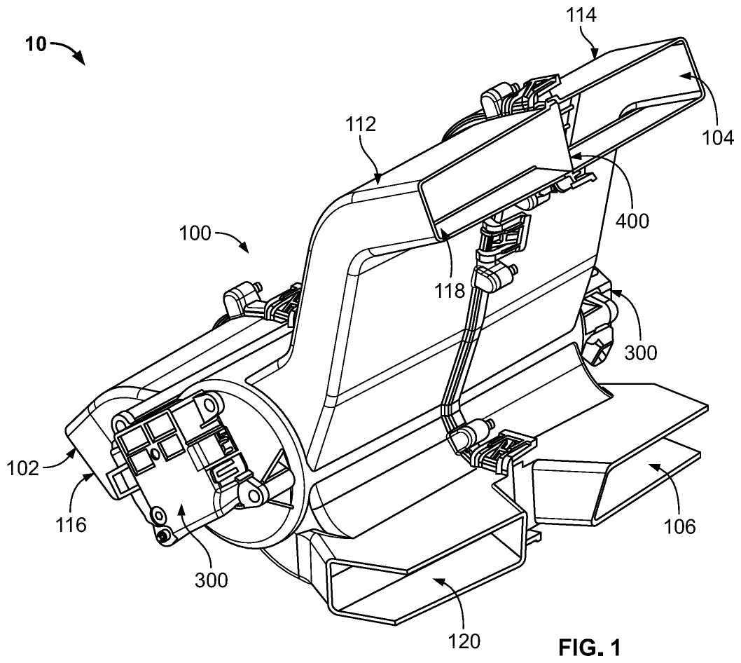

Referring to FIG. 1, an HVAC zone assembly, shown as zone assembly 10, is configured to selectively provide air from a heating and/or cooling system to a vehicle cabin within a vehicle. The vehicle may be a passenger vehicle, a commercial vehicle, a construction vehicle, a utility vehicle, or another type of vehicle. The vehicle may include a vehicle body defining the vehicle cabin. The vehicle body may be configured to protect a user from weather, road debris, or another environmental hazard.

The heating and/or cooling system, referred to hereinafter as an HVAC system, may be disposed within the vehicle body. The HVAC system may be configured to provide conditioned air to the vehicle cabin to maintain the space within a comfortable temperature range for the user. The HVAC system may be configured as an air conditioning system, an engine heat recovery system, etc. The HVAC system may include a series of ducts and fans to direct the flow of conditioned air toward the zone assembly 10.

As shown in FIG. 1, the zone assembly 10 includes a housing 100 including an inlet opening 102, a first vent opening 104, and a second vent opening 106. The second vent opening 106 is substantially vertically aligned with the first vent opening 104 and disposed above the first vent opening 104. In an embodiment, the first vent opening 104 is configured to deliver conditioned air to a vent disposed centrally within, or within an upper portion of, the vehicle cabin. The second vent opening 106 is configured to deliver conditioned air proximate to a floor of the vehicle cabin. In an embodiment, the zone assembly 10 may be configured as a rear HVAC zone assembly that provides and distributes conditioned air to a rear portion of the vehicle cabin.

In an embodiment, the housing 100 is configured as a two-part housing. Each portion of the housing 100 may be configured to deliver conditioned air to a different region (e.g., portion, area, part, etc.) of the vehicle cabin. For example, a first portion 112 of the housing 100 may be configured to provide air to a driver side (e.g., a left side when facing toward a front of the vehicle, etc.) of the vehicle cabin, while a second portion 114 of the housing 100 may be configured to provide air to a passenger side (e.g., a right side when facing toward a front of the vehicle, etc.) of the vehicle cabin.

The second portion 114 of the housing 100 may be substantially identical to a mirror reflection of the first portion 112 of the housing 100 or may include a different configuration according to other illustrative embodiments. The first portion 112 of the housing 100 may be removably coupled to the second portion 114 to facilitate maintenance of the zone assembly 10. The first portion 112 and the second portion 114 may be coupled to one another using any suitable fastener such as bolts, screws, clips, tabs, or any combination thereof. In the embodiment of FIG. 1, the first portion 112 is removably coupled to the second portion 114 using a combination of bolts and clips.

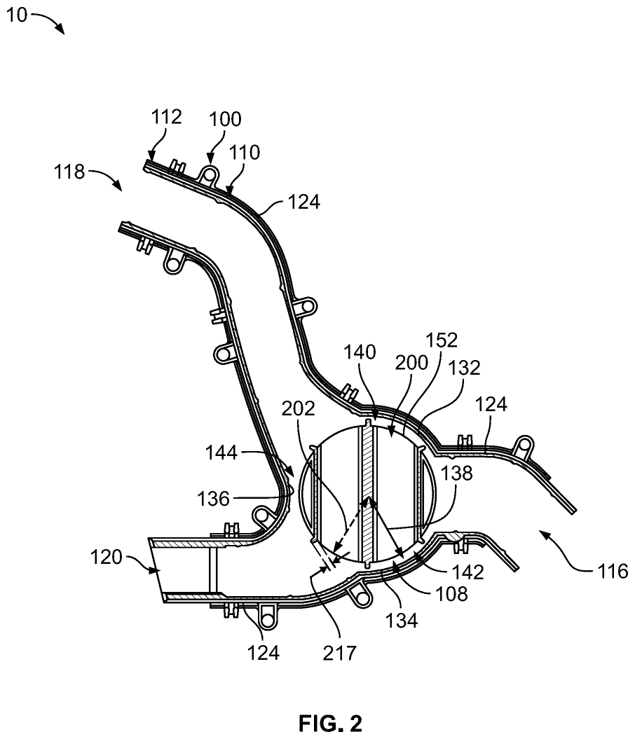

An illustrative embodiment of each of the first portion 112 of the housing 100 and the second portion 114 of the housing 100 is shown in FIGS. 2-4 and FIGS. 5-6, respectively. Each of the first portion 112 and the second portion 114 may be formed from a single piece of material or from multiple pieces of material welded or otherwise secured together. In an embodiment, each portion 112, 114 is made from a single piece of plastic (e.g., nylon, polycarbonate, etc.) produced by an injection molding operation. In another embodiment, each portion 112, 114 is made from one or more pieces of metal (e.g., aluminum, steel, etc.) produced by a stamping and/or bending operation.

As shown in FIGS. 2-4, the housing 100 includes a wall 110 defining the first portion 112 of the housing 100. The wall 110 defines a cavity 108, an inlet channel 116, a first vent channel 118, and a second vent channel 120. The wall 110 for each channel 116, 118, 120 includes a base wall 122 and two side walls 124 coupled to the base wall 122 (e.g., oriented substantially perpendicular thereto). The base walls 122 for each channel 116, 118, 120 are approximately coplanar with one another. Together, the base wall 122 and the side walls 124 for each channel 116, 118, 120 are configured substantially in the shape of a U-channel.

The inlet channel 116, the first vent channel 118, and the second vent channel 120 are separated from one another by the cavity 108, which is disposed centrally within the first portion 112 of the housing 100. As shown in FIG. 2, the cavity 108 is configured to receive a mode door 200. As shown in FIG. 4, the cavity 108 includes a substantially cylindrical recessed portion 126 and an opening 128 disposed centrally thereon. A lower wall 130 of the recessed portion 126 is substantially parallel to the base wall 122 of each channel 116, 118, 120 and spaced a distance from the base wall 122. As shown in FIG. 2, an end of the mode door 200 is configured to be received by the recessed portion 126. Among other benefits, recessing the mode door 200 relative to the base walls 122 helps prevent air in the inlet channel 116 from bypassing the mode door 200 around the end of the mode door 200 (e.g., between an outer surface of the end of the mode door 200 and the lower wall 130, through a separation formed between the outer surface of the mode door 200 and the lower wall 130, etc.).

Referring still to FIGS. 2-4, the cavity 108 includes a plurality of arcuate sections (e.g., curved sections, etc.) of approximately constant radius. Each arcuate section defines a portion of an outer perimeter of the cavity 108. In the embodiment of FIG. 4, the cavity 108 includes three arcuate sections, shown as first arcuate section 132, second arcuate section 134, and third arcuate section 136. As shown in FIG. 4, the first arcuate section 132 extends between the inlet channel 116 and the first vent channel 118, the second arcuate section 134 extends between the inlet channel 116 and the second vent channel 120, and the third arcuate section 136 extends between the first vent channel 118 and the second vent channel 120.

As shown in FIG. 2, the arcuate sections 132, 134, 136 are configured to reduce flow bypass from the inlet channel 116 through the mode door 200 (e.g., from the inlet channel 116 to the first vent channel 118 and the second vent channel 120, etc.). More specifically, the arcuate sections 132, 134, 136 are configured to interface with the mode door 200 in a manner that prevents flow bypass through a substantially radial separation formed between the mode door 200 and the wall 110 of the housing 100.

As shown in FIG. 2, an inner radius 138 of each of the arcuate sections 132, 134, 136 is slightly larger than an outer radius 202 of the mode door 200. The difference in radius results in a separation (e.g., a clearance gap, a flow space, etc.) between the mode door 200 and the wall 110 of the housing 100. The separation defines a first flow passage 140 that extends between the inlet channel 116 and the first vent channel 118, a second flow passage 142 that extends between the inlet channel 116 and the second vent channel 120, and a third flow passage 144 that extends between the first vent channel 118 and the second vent channel 120.

An angular extent of each of the flow passages 140, 142, 144 along a flow direction (e.g., a substantially circumferential direction, etc.) is approximately equal to an angular extent of the arcuate section 132, 134, 136 bounding the flow passage 140, 142, 144. In an illustrative embodiment, as shown in FIG. 4, an angular extent 146 of the first arcuate section 132 is approximately equal to an angular extent 148 of the second arcuate section 134. The angular extent 150 of the third arcuate section 136 is less than the angular extent 146, 148 of either the first arcuate section 132 or the second arcuate section 134. Advantageously, the first arcuate section 132 and the second arcuate section 134 are sized to accommodate at least two extension pieces 206 of the mode door 200 simultaneously. In other embodiments, the angular extent of any one of the arcuate sections 132, 134, 136 may be different.

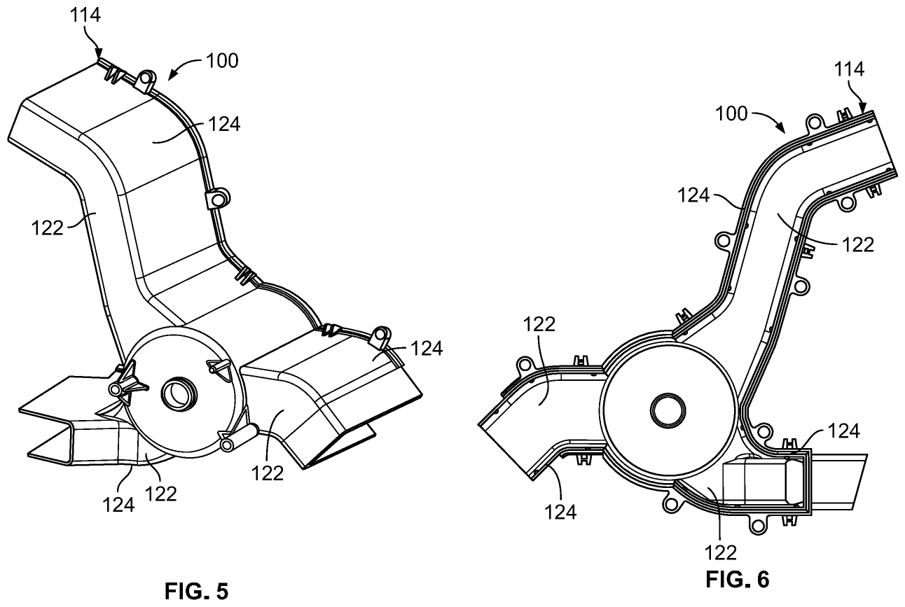

As shown in FIGS. 5-6, the second portion 114 of the housing 100 is substantially similar to the first portion 112. The second portion 114 is approximately a mirror image of the first portion 112 (e.g., a mirror reflection across a plane oriented substantially parallel to the base wall 122, the plane spaced a distance from the base wall 122, the distance approximately equal to a height of the side walls 124, etc.).

As shown in FIG. 1, the first portion 112 of the housing 100 may be separated from the second portion 114 by a partition member 400 disposed proximate to where the first portion 112 engages with the second portion 114. The partition member 400 is secured between side walls 124 of the first portion 112 and the second portion 114. Together, the partition member 400 and the first portion 112 form a first internal volume configured to guide (e.g., channel, direct, etc.) conditioned air to the driver side of the vehicle cabin. The partition member 400 and the second portion 114 form a second internal volume configured to guide (e.g., channel, direct, etc.) conditioned air to the passenger side of the vehicle cabin.

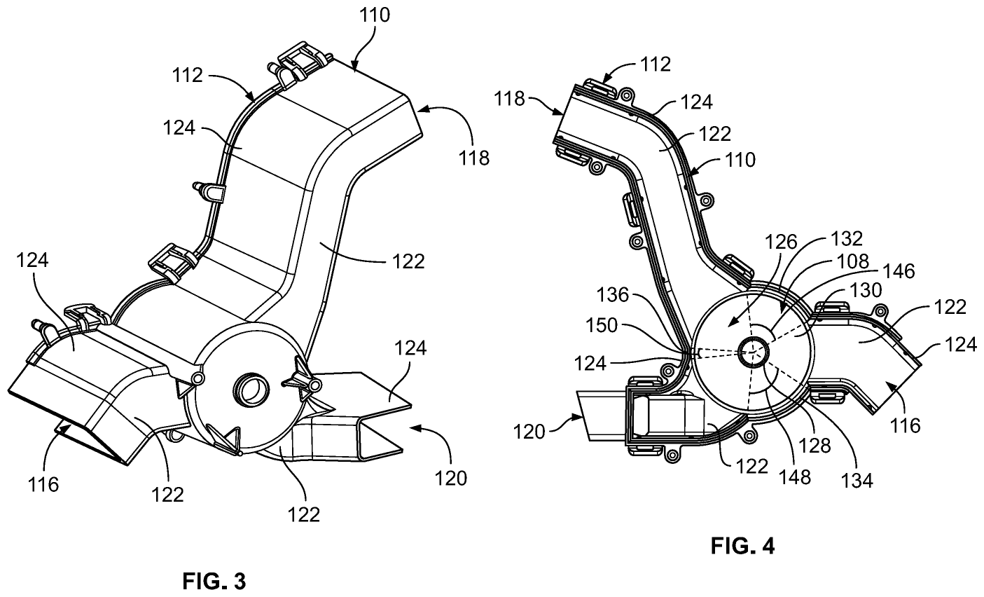

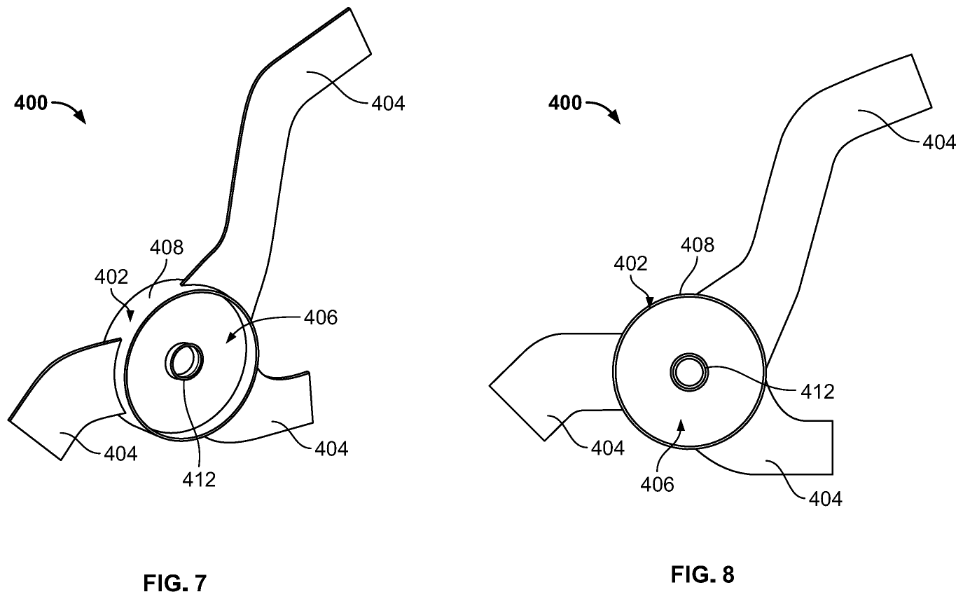

As shown in FIGS. 7-8, the partition member 400 includes a central hub 402 and a plurality of channel partition members 404. The central hub 402 is configured to receive an end of the mode door 200 (not shown). For example, the central hub 402 may be configured to receive an end cap of the mode door 200 to both position the mode door 200 and to prevent air from bypassing the mode door 200. The central hub 402 includes a recessed area 406 on either side of the hub 402, which is defined, in part, by a substantially cylindrical outer wall 408 that extends around a perimeter of the recessed area 406. An outer radius of the outer wall 408 may be smaller than an inner radius 138 of any of the arcuate sections 132, 134, 136 (see also FIGS. 3-4) to help align the partition member 400 with respect to the housing 100. The hub 402 also includes a substantially cylindrical inner wall 412 disposed centrally within the recessed area 406. In an embodiment, the inner wall 412 is configured to support an extension piece (not shown) of the mode door 200 to center the mode door 200 within the recessed area 406. In some embodiments, an axial height of the inner wall 412 is less than an axial height of the outer wall 408 to improve sealing between the mode door 200 and the partition member 400 (e.g., to further recess the end of the mode door 200 within the partition member 400, etc.).

As shown in FIGS. 7-8, the partition member 400 includes a plurality of channel partition members 404 disposed along an outer perimeter of the central hub 402. The channel partition members 404 extend from the outer wall 408 in a generally radial direction outward (e.g., away, outwardly, etc.) from the central hub 402 along each of the inlet channel 116, the first vent channel 118, and the second vent channel 120 (see also FIGS. 3-4).

Referring back to FIG. 2, the zone assembly 10 includes a mode door 200 configured to control the flow of air through the housing 100. In an illustrative embodiment, the first portion 112 and the second portion 114 of the housing 100 (see also FIG. 1) include their own individual mode doors 200. Among other benefits, this allows the zone assembly 10 to independently control the flow of air on the passenger side and driver side of the vehicle cabin. In other embodiments, a single mode door 200 may be shared between the first portion 112 and the second portion 114.

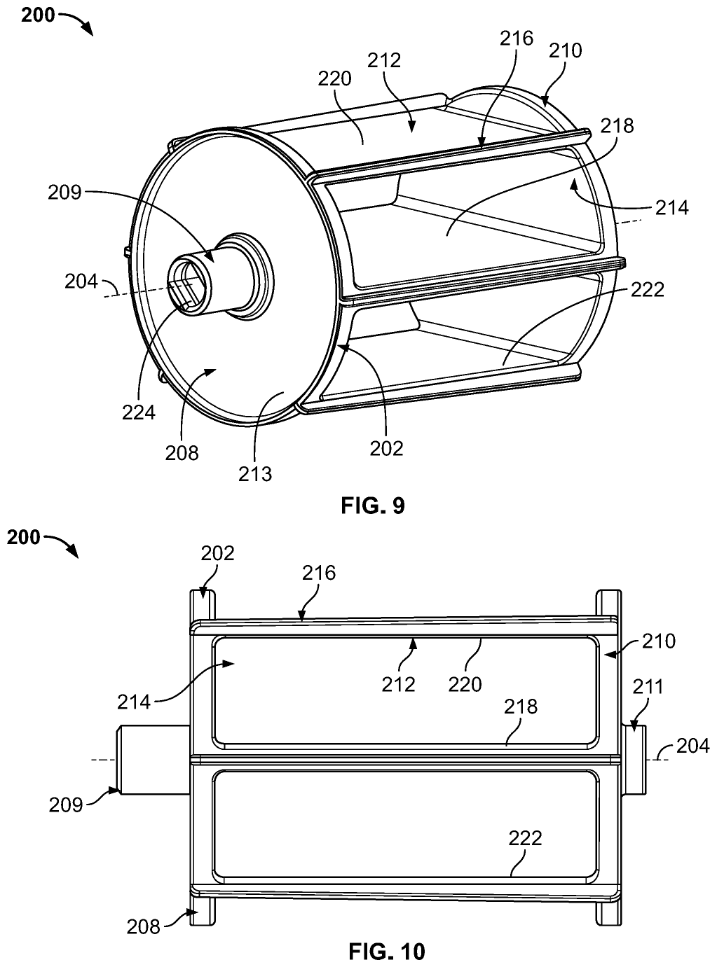

The mode door 200 is configured to control the flow of conditioned air to both the first vent channel 118 and the second vent channel 120. In an illustrative embodiment, as shown in FIGS. 9-10, the mode door 200 includes a substantially cylindrical member disposed on either end of the mode door 200, shown as first cap 208 and second cap 210. The caps 208, 210 are oriented substantially parallel to one another. The caps 208, 210 are separated by a distance that is approximately equal to a distance between the lower wall 130 of the housing 100 and the recessed area 406 of the partition member 400 (see also FIG. 1). Each of the caps 208, 210 may be configured as a flat circular disk. Alternatively, as shown in FIGS. 9-10, each cap 208, 210 may include a recessed section 213 at an axial end of the mode door 200, which, advantageously, facilitates sealing of the mode door 200 against one of the partition member 400 and housing 100.

As shown in FIGS. 9-10, the mode door 200 includes a plurality of louvers 212 extending between the first cap 208 and the second cap 210. The louvers 212 are oriented in a direction that is substantially perpendicular to the caps 208, 210 (i.e., substantially parallel to a central axis 204 of the mode door 200). Together, the louvers 212 define at least one substantially longitudinal passage 214 through the mode door 200. The geometry, number, and arrangement of louvers 212 may vary depending on the flow requirements and/or the number of vent channels in the zone assembly 10. In the embodiment of FIGS. 9-10, the mode door 200 includes three louvers 212 configured as a plurality of substantially parallel walls. A first louver 218 is disposed along the central axis 204 of the mode door 200 and extends along an entire diameter of the caps 208, 210. The remaining louvers, shown as second louver 220 and third louver 222, are disposed on opposite sides of the first louver 218. The second louver 220 and the third louver 222 are separated approximately an equal distance from the first louver 218.

The mode door 200 is substantially cylindrical and has mirror symmetry across a plane passing through the central axis 204 of the mode door 200 (e.g., a plane oriented in a direction that is substantially parallel to the central axis 204 of the mode door 200). Among other benefits, using a cylindrical and symmetrical mode door 200 helps balance the mode door 200 and prevents the mode door 200 from being biased into any single flow position by flow received from the inlet channel 116 (see FIG. 2).

Still referring to FIGS. 9-10, the mode door 200 additionally includes a plurality of extension pieces 216, each extension piece 216 at least partially disposed on one of the louvers 212 at an outer radius 202 of the mode door 200. Each extension piece 216 extends substantially radially outward from a corresponding one of the louvers 212, such that each extension piece 216 protrudes beyond an outer perimeter of the caps 208, 210. In other embodiments, the extension pieces 216 may extend substantially parallel to the louvers 212, or at another angle relative to louvers 212. Among other benefits, using extension pieces 216 that extend in a substantially radial direction maximizes the cross-sectional area for flow through the mode door 200.

The extension pieces 216 may be formed in a variety of different ways. For example, each of the extension pieces 216 may be formed with the mode door 200 as a single piece of material (e.g., as a plurality of ribs on the mode door 200 via an injection molding process, etc.). Alternatively, each of the extension pieces 216 may be formed as a separate piece of material that is coupled to the mode door 200 (e.g., welded, adhered, or otherwise fastened). In an embodiment where the extension pieces 216 are formed separated from the mode door 200, the extension pieces 216 may be made from a different material than the mode door 200. For example, the mode door 200 may be made from plastic (e.g., nylon, polycarbonate, etc.) via an injection molding process. The extension pieces 216 may be made from foam, rubber, or another compliant material configured to engage with the mode door 200. The extension pieces 216 may be configured to press against the wall 110 (see FIG. 2) of the housing 100 at an inner radius 138 of the arcuate sections 132, 134, 136 to prevent air from bypassing the extension pieces 216. Alternatively, the extension pieces 216 may be separated a small distance from the inner radius 138 of the arcuate sections 132,134, 136 to restrict air from flowing through a separation (e.g., the first flow passage 140, the second flow passage 142, or the third flow passage 144) between the mode door 200 and the wall 110.

In the embodiment of FIGS. 9-10, the extension pieces 216 are formed as part of the mode door 200. The extension pieces 216 are configured as small radial extensions that protrude outwardly from the louvers 212 at the outer radius 202 of the mode door 200. A thickness of each of the extension pieces 216 is slightly less than a thickness of each of the louvers 212. In other embodiments, the thickness of the extension pieces 216 is approximately equal to or greater than the thickness of each of the louvers 212.

As shown in FIG. 2, a radial dimension 217 of each of the extension pieces 216 is slightly less than a radial dimension 152 of the separation between the outer radius 202 of the mode door 200 and the inner radius 138 of the arcuate sections 132, 134, 136. Advantageously, a slight clearance fit between the extension pieces 216 and the wall 110 of the housing 100 reduces the rotational resistance of the mode door 200 while still providing adequate flow restriction to prevent air from passing between the extension pieces 216 and the housing 100. Providing a clearance gap also reduces the operational noise of the zone assembly 10 (as opposed to a configuration where the extension pieces 216 contact and rub against the housing 100). In an illustrative embodiment, a tolerance of the radial dimension of each of the extension pieces 216 is within 5 mm, although the tolerance may be more or less depending on the forming method and materials used.

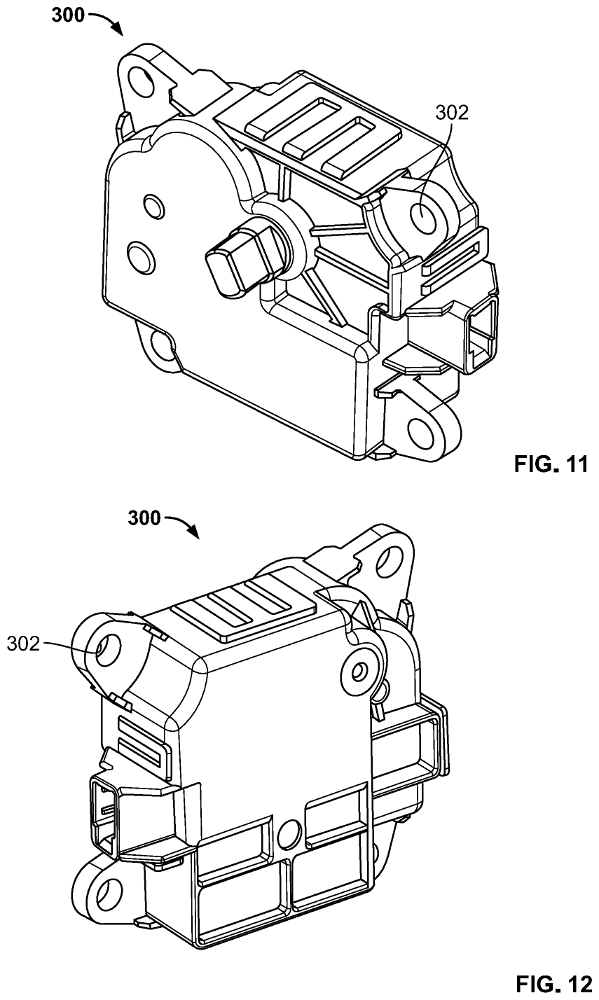

The mode door 200 includes a support member disposed on either end of the mode door 200. As shown in FIGS. 9-10, a first support member 209 is disposed on a first end of the mode door 200, while a second support member 211 is disposed on a second (e.g., opposite) end of the mode door 200. Together, the support members 209, 211 are configured to rotatably couple the mode door 200 to the zone assembly 10, between the partition member 400 (see FIGS. 7-8) and the mode actuator 300 (see FIGS. 11-12), such that the mode door 200 may rotate about a central axis of the mode door 200 within the zone assembly 10. In an illustrative embodiment, as shown in FIGS. 9-10, each of the support members 209, 211 is configured as a substantially cylindrical extension (e.g., a circular post, a cylindrical shaft, etc.) that extends in a substantially axial direction from an outer surface of one of the caps 208, 210. A first support member 209 is configured to engage with a mode actuator 300 (see FIGS. 11-12), while a second support member 211 is configured to engage with the inner wall 412 of the partition member 400 (see FIGS. 7-8). The first support member 209 includes a connecting member 224 (e.g., a slot, a recessed portion, etc.) configured to facilitate engagement of the mode door 200 with the mode actuator 300.

Referring back to FIG. 1, the zone assembly 10 includes a mode actuator 300 disposed on the wall 110 of the housing 100. As shown in FIGS. 11-12, the mode actuator 300 includes a plurality of mounting points 302 configured to removably couple the mode actuator 300 to the housing 100. The mounting points 302 may be configured to receive one, or a combination of, bolts, screws, clips, tabs, or another mechanical fastener to secure the mode actuator 300 to the housing 100.

The mode actuator 300 is configured to rotate the mode door 200 (see FIGS. 9-10) about a central axis 204 of the mode door 200 and thereby regulate the flow of conditioned air from the inlet channel 116 to at least one of the first vent channel 118 and the second vent channel 120 (see also FIGS. 3-4). In an illustrative embodiment, as shown in FIGS. 11-12, the mode actuator 300 is configured as a rotatory actuator (e.g., an electro-mechanical actuator, etc.). The actuator may be configured as a four position actuator with return (i.e., to rotate the mode door 200 between multiple positions within 180° and to reverse the rotational direction in order to return the mode door 200 to previous positions), or as multi-position step actuator that may be configured to rotate the mode door 200 over 180° or 360°.

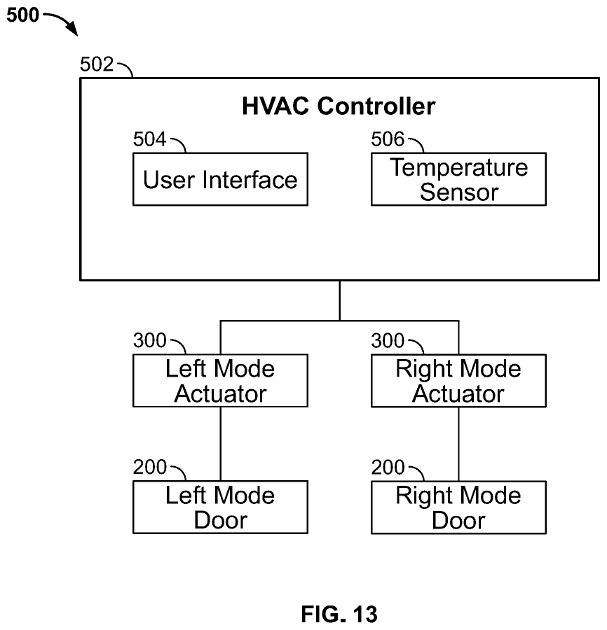

In an illustrative embodiment, as shown in FIG. 13, the zone assembly 10 includes a control system 500 configured to coordinate the movement of the mode door 200 in response to a user input and/or a condition of the vehicle cabin (e.g., temperature, pressure, flow rate, etc.). The control system 500 may include an HVAC controller 502 including a user interface 504 and an HVAC sensor, shown as temperature sensor 506. The HVAC controller 502 may be communicatively coupled to a mode actuator 300 for the left side (i.e., driver side) of the vehicle cabin and a mode actuator 300 for the right side (i.e., passenger side) of the vehicle cabin. The HVAC controller 502 may be configured to receive commands from the user interface 504 (e.g., desired temperature, flow rate, position of air flow, etc.) and the temperature sensor 506 (e.g., actual measured temperature of the driver side or passenger side, etc.). The HVAC controller 502 may include a processor configured to compare user inputs from the user interface 504 with actual operating conditions and generate a control signal. The mode actuators 300 may be configured to receive the control signal and rotate the mode door 200 (see also FIGS. 9-10) to the desired position to control the flow of air to the vehicle cabin.

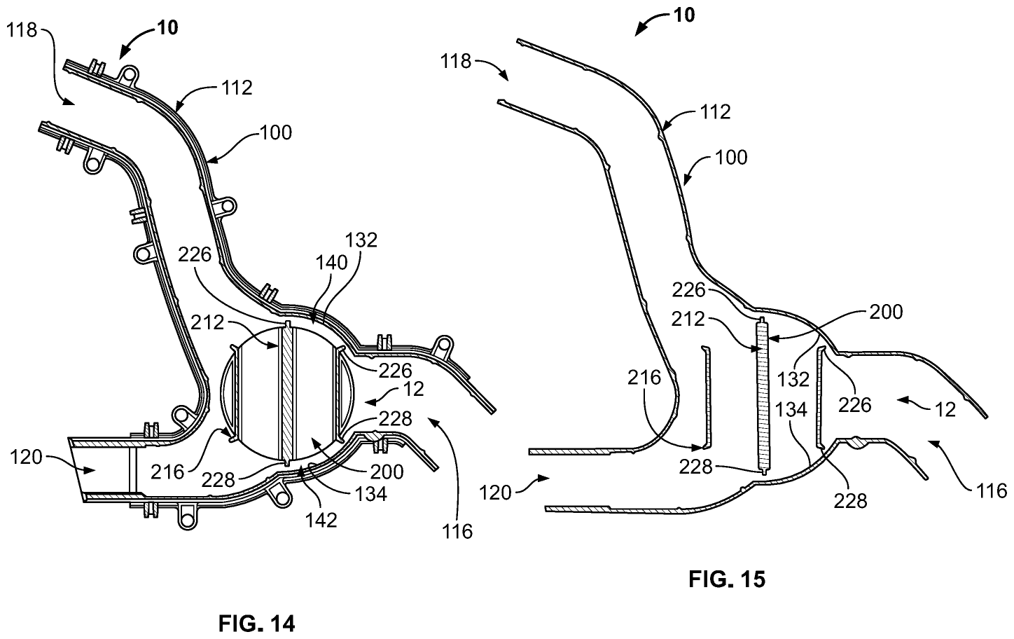

In the embodiment of FIG. 1, the mode door 200 is configured to simultaneously provide flow distribution control and on/off flow control to each of the vent channels 118, 120. FIGS. 14-21 show an illustrative embodiment of the zone assembly 10, at a cross section through the first portion 112 of the housing 100. The mode door 200 is rotatable (e.g., reconfigurable, etc.) between an open position in which the inlet channel 116 is fluidly coupled (e.g., guides, directs, or channels fluid) to at least one of the vent channels 118, 120 (e.g., such that fluid may flow from the inlet channel 116 to one or both of the vent channels 118, 120), and a closed position in which the mode door 200 restricts (e.g., prevents, etc.) fluid from flowing through the vent channels 118, 120.

FIGS. 14-15 show the zone assembly 10 with the mode door 200 configured in the closed position. In the closed position, a first pair of extension pieces 226 is positioned in the first flow passage 140 between the inlet channel 116 and the first vent channel 118, while, at the same time, a second pair of extension pieces 228 is positioned in the second flow passage 142 between the inlet channel 116 and the second vent channel 120. Among other benefits, using pairs of extension pieces 226, 228 to block the flow in the closed position, where the pressure drop across the mode door 200 is highest, helps to increase the flow restriction and decrease the quantity of air bypassing the mode door 200 into either vent channel 118, 120. Using extension pieces 216 that are substantially radial ensures that the clearance between each extension piece 216 and the first arcuate section 132 or the second arcuate section 134 is approximately constant (e.g., the same as the extension pieces 216 rotate across the first arcuate section 132 or the second arcuate section 134). As shown in FIGS. 14-15, in the closed position, the louvers 212 are oriented in a direction that is substantially perpendicular to a flow direction 12 of air through the inlet channel 116 (i.e., substantially perpendicular to a flow direction 12 of air through the inlet channel 116, proximate to where the inlet channel 116 meets with the mode door 200).

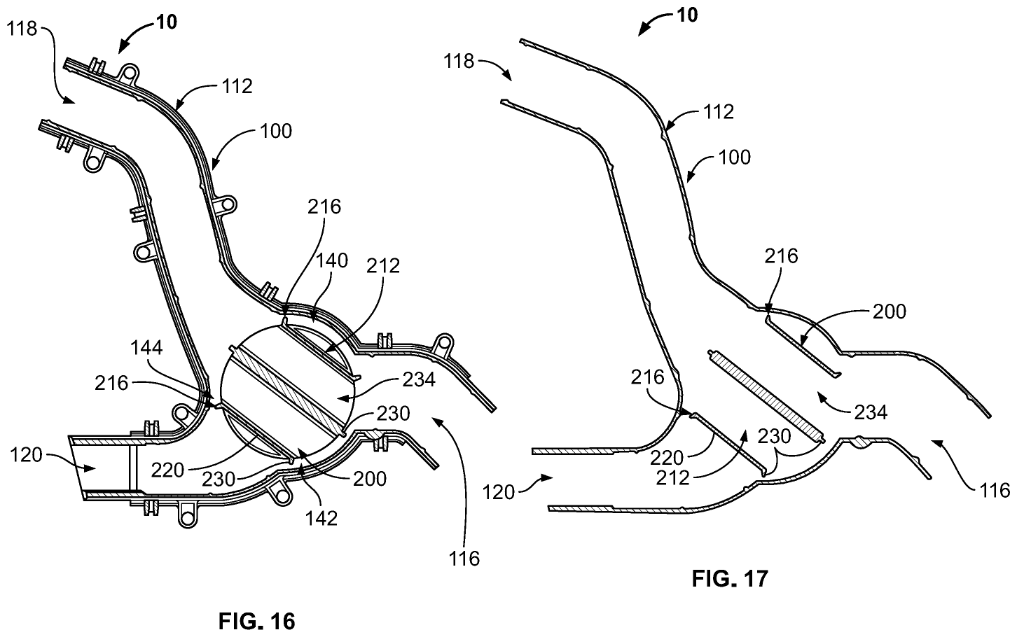

As shown in FIGS. 16-21, the mode door 200 may be configured to include multiple “open” positions. In an illustrative embodiment, there are three different “open” positions, including a vent position in which the inlet channel 116 is fluidly coupled to the first vent channel 118 in isolation of the second vent channel 120, a floor position in which the inlet channel 116 is fluidly coupled to the second vent channel 120 in isolation of the first vent channel 118, and a bi-level position in which the inlet channel is fluidly coupled to both the first vent channel 118 and the second vent channel 120.

In each of the flow configurations shown in FIGS. 16-21, flow moves from the inlet channel 116, through an open space in between the louvers 212, to one or both vent channels 118, 120. Each one of the extension pieces 216 is coupled to a louver and extends from the louver 212 at an angle with respect to a plane passing through the louver 212. In the embodiments of FIGS. 16-21, the extension pieces 216 extend in a substantially radial direction. Among other benefits, using extension pieces 216 that are angled relative to the louvers 212 maximizes the cross-sectional area for flow at either end of the open space between louvers 212 (e.g., increases the cross-sectional area for flow as compared to a mode door 200 having extension pieces 216 that extend parallel to the louver 212). The arrangement of the extension pieces 216 can, advantageously, reduce flow restriction through the mode door 200 in each “open” position.

FIGS. 16-17 show the mode door 200 configured in the vent position. In the vent position, the mode door 200 is configured to guide (e.g., direct, channel, etc.) air from the inlet channel 116 to the first vent channel 118. As shown in FIGS. 16-17, the louvers 212 are substantially aligned with an entrance to the first vent channel 118 such that a first longitudinal passage 234 fluidly couples the inlet channel 116 to the first vent channel 118. Using extension pieces 216 that extend in a substantially radial direction maximizes the cross-sectional area for flow through the first longitudinal flow passage 234. The mode door 200 is configured such that only a single extension piece 216 is disposed in the first flow passage 140. Note that fewer extension pieces 216 are needed to restrict air from flowing through the first flow passage 140 in the vent position, due to a reduction in the pressure drop between the inlet channel 116 and the first flow passage 140. A third pair of extension pieces 230 at least partially bucks flow through the second flow passage 142, while only a single extension piece 216 blocks flow through the third flow passage 144. Accordingly, a single louver 212 (e.g., the second louver 220) substantially blocks the second vent channel 120.

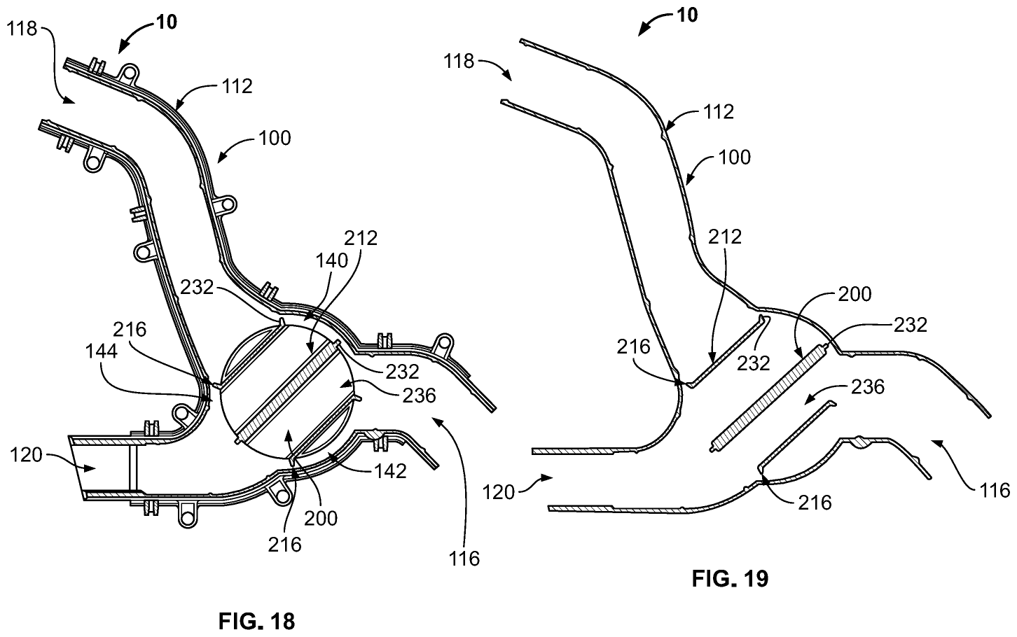

FIGS. 18-19 show the mode door 200 configured in the floor position. The floor position is substantially similar to the vent position, but with the mode door 200 configured to guide (e.g., direct, channel, etc.) air from the inlet channel 116 to the second vent channel 120 instead of the first vent channel 118. As shown in. FIGS. 18-19, the louvers 212 are substantially aligned with an entrance to the second vent channel 120 such that a second longitudinal passage 236 fluidly couples the inlet channel 116 with the second vent channel 120. Using extension pieces 216 that extend in a substantially radial direction maximizes the cross-sectional area for flow through the second longitudinal flow passage 236. The mode door 200 is configured such that only a single extension piece 216 is disposed in the second flow passage 142. A fourth pair of extension pieces 232 at least partially bucks flow through the first flow passage 140, while only a single extension piece 216 blocks flow through the third flow passage 144. Accordingly, a single louver 212 (e.g., the second louver 220) substantially blocks flow from passing into the first vent channel 118.

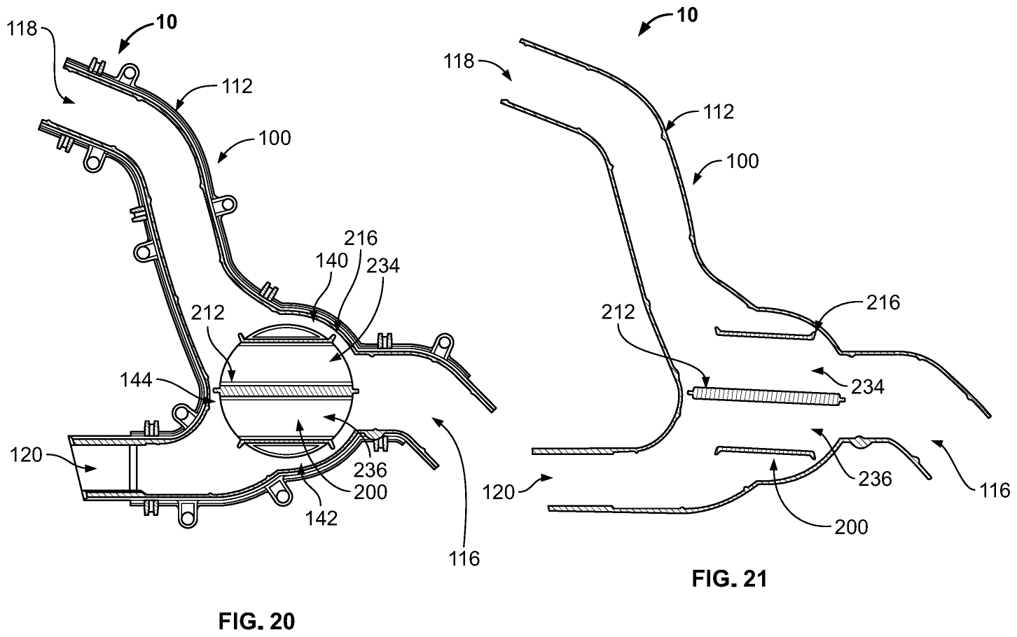

FIGS. 20-21 show the mode door 200 configured in a bi-level position in which air is guided from the inlet channel 116 through both vent channels 118, 120. In the bi-level position, the first longitudinal passage 234 guides air from the inlet channel 116 to the first vent channel 118, while the second longitudinal passage 236 guides air from the inlet channel 116 to the second vent channel 120. Using extension pieces 216 that extend in a substantially radial direction maximizes the cross-sectional area available for flow through the longitudinal flow passages 234, 236. Note that, in the bi-level position, the flow leaving the inlet channel 116 is distributed approximately evenly between the first vent channel 118 and the second vent channel. 120. Note further that the flow rate of air delivered to each of the first vent channel 118 and the second vent channel 120 is substantially similar to (i.e., does not exceed, etc.) the flow rate of air delivered when the mode door 200 is configured in the vent and floor positions, respectively. Only a single extension piece 216 is disposed in each of the flow passages 140, 142, 144, which is sufficient to mitigate flow bypass through the flow passages 140, 142, 144 proximate to an outer perimeter of the mode door 200 in the bi-level position.

The flow configurations described with reference to the illustrative embodiments of FIGS. 1-21 should not be considered limiting. Various alternatives are possible without departing from the inventive concepts disclosed herein. For example, more or fewer extension pieces 216 and louvers 212 may be provided. The number of vent channels 118, 120 could also be modified to suit the needs of the vehicle cabin. Furthermore, more or fewer rotational positions of the mode door 200 relative to the housing 100 may be utilized to modify the distribution of flow through the vent passages 118, 120.

The zone assembly 10 and associated components, of which various illustrative embodiments are disclosed herein, provide several advantages over conventional vehicle zone control systems. A housing for the zone assembly includes a wall defining a cavity within which a mode door is received. A substantially radial separation between the wall and the mode door defines a series of flow passages. Each flow passage extends along the wall between an inlet channel of the housing, which is configured to receive conditioned air from the HVAC system, and one of a plurality of vent channels, each of which are configured to deliver the conditioned air to a different region within a vehicle cabin. The mode door includes a plurality of extension pieces that extend outward from an outer radius of the mode door and toward the wall of the housing. The extension pieces are configured to block the flow passages defined by a separation between the mode door and the wall to prevent flow from bypassing the mode door. The number of extension pieces occupying a given flow passage varies depending on whether the mode door is positioned to close off the vent channel from the inlet channel or to fluidly couple the vent channel to the inlet channel.

The mode door 200 is configured such that at least two extension pieces 216 occupy the flow passage 140, 142 when the corresponding vent channel 118, 120 is closed off from the inlet channel 116. This added restriction helps to prevent any air from bleeding from the inlet channel 116 into a closed off vent channel 118, 120. Only one extension piece 216 occupies the flow passage 140, 142, 144 when the corresponding vent channel 118, 120 is open to the inlet channel 116. The pressure drop between the inlet channel 116 and the vent channel 118, 120 is reduced in the open position, and hence fewer extension pieces 216 are required to prevent air from bypassing the mode door 200 through the flow passage 140, 142. Among other benefits, the zone assembly 10 is designed to simultaneously provide on/off control as well as directional control using a single mode door 200, which reduces the number of components required in the zone assembly 10. Advantageously, the mode door 200 is substantially cylindrical, symmetrical, and is configured to rotate over center, allowing for the use of multiple different types of rotary actuators and control schemes.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or movable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below” are merely used to describe the orientation of various elements in the FIGURES. It should be noted that the orientation of various elements may differ according to other illustrative embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) Without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various illustrative embodiments without departing from the scope of the present invention.

What is claimed is:

1. An HVAC zone assembly for a vehicle comprising:
a housing including a cavity, an inlet channel, a first vent channel, and a second vent channel, wherein the inlet channel, the first vent channel, and the second vent channel extend from the cavity and are fluidly coupled to the cavity; and
a generally cylindrical mode door located in the cavity, the mode door comprising:
a plurality of louvers defining at least one substantially longitudinal flow passage configured to guide fluid through the mode door from the inlet channel to the first vent channel or the second vent channel; and
a plurality of extension pieces, wherein the extension pieces extend from the louvers,
wherein the mode door is rotatable between an open position in which fluid may flow from the inlet channel through the mode door to one of the first vent channel or the second vent channel, and a closed position in which the mode door restricts fluid from flowing from the inlet channel to both the first vent channel and the second vent channel.

2. The HVAC zone assembly of claim 1, wherein the housing comprises a wall defining the cavity, and further comprising a separation between the mode door and the wall, the separation defining a first flow passage that extends between the inlet channel and the first vent channel, and a second flow passage that extends between the inlet channel and the second vent channel.

3. The HVAC zone assembly of claim 2, wherein in the closed position a first pair of the extension pieces is positioned in the first flow passage and a second pair of the extension pieces is positioned in the second flow passage.

4. The HVAC zone assembly of claim 2, wherein in the open position, only a single extension piece is disposed in at least one of the first flow passage and the second flow passage.

5. The HVAC zone assembly of claim 2, wherein the separation further defines a third flow passage that extends between the first vent channel and the second vent channel, wherein in the open position, only a single extension piece is disposed in the third flow passage.

6. The HVAC zone assembly of claim 1, wherein the extension pieces are spaced apart from the housing.

7. The HVAC zone assembly of claim 1, wherein the inlet channel is configured to guide air toward the mode door, wherein the first vent channel is configured to guide air toward a vent opening in a vehicle cabin above the second vent channel, and wherein the second vent channel is configured to guide air toward an opening proximate to a floor of the vehicle cabin.

8. The HVAC zone assembly of claim 1, wherein the open position is one of:
a vent position in which the inlet channel is fluidly coupled to the first vent channel in isolation from the second vent channel; and
a floor position in which the inlet channel is fluidly coupled to the second vent channel in isolation from the first vent channel.

9. The HVAC zone assembly of claim 8, wherein in the vent position at least two extension pieces are positioned in a flow path between the inlet channel and the second vent channel and only a single extension piece is positioned in a flow path between the inlet channel and the first vent channel, and wherein in the floor position at least two extension pieces are positioned in a flow path between the inlet channel and the first vent channel and only a single extension piece is positioned in a flow path between the inlet channel and the second vent channel.

10. A mode door for an HVAC zone assembly comprising:
a first cylindrical cap disposed on a first end of the mode door;
a second cylindrical cap disposed on a second end of the mode door;
a plurality of louvers extending between the first cylindrical cap and the second cylindrical cap, the louvers defining at least one substantially longitudinal passage; and
a plurality of extension pieces, each extension piece at least partially disposed on a louver and extending outward from the louver,
wherein the mode door is configured to be received within a cavity of a housing, wherein each extension piece is configured to restrict air from flowing through a separation between the mode door and the housing.

11. The mode door of claim 10, wherein each extension piece extends from the louver at an angle with respect to a plane passing through the louver.

12. The mode door of claim 11, wherein each extension piece extends from the louver in a substantially radial direction away from a central axis of the mode door.

13. The mode door of claim. 10, wherein the mode door is configured to be rotatably coupled to the housing, wherein the mode door is configured to rotate about a central axis of the mode door.

14. The mode door of claim 10, wherein the mode door has mirror symmetry across a plane passing through a central axis of the mode door, and wherein the plane is oriented in a direction that is substantially parallel to the central axis.

15. The mode door of claim 10, wherein the plurality of louvers comprises at least three louvers that are oriented substantially parallel to one another, wherein the mode door is reconfigurable between an open position in which an inlet channel of the housing is coupled to at least one of a first vent channel of the housing and a second vent channel of the housing by only a single longitudinal passage.

16. A housing for an HVAC zone assembly comprising:
a cavity configured to receive a mode door, the cavity comprising a first arcuate section, a second arcuate section, and a third arcuate section; and
an inlet channel, a first vent channel, and a second vent channel extending from the cavity,
wherein the first arcuate section extends between the inlet channel and the first vent channel, the second arcuate section extends between the inlet channel and the second vent channel, and the third arcuate section extends between the first vent channel and the second vent channel.

17. The housing of claim 16, wherein a radius of the first arcuate section is approximately equal to a radius of both the second arcuate section and the third arcuate section.

18. The housing of claim 17, wherein an angular extent of each of the first arcuate section and the second arcuate section is greater than an angular extent of the third arcuate section.

19. The housing of claim 16, the cavity further comprising a recessed portion, wherein the recessed portion is substantially cylindrical.

20. The housing of claim 16, the housing including a wall defining a first portion of the housing, the housing further comprising a second portion coupled to the first portion, wherein the second portion is substantially identical to a mirror reflection of the first portion.

21. The housing of claim 16, wherein the mode door is rotatably coupled to the housing.
